(19) United States
(12) Patent Application Publication
(10) Pub. No.: US 2006/0204846 A1
(43) Pub. Date: Sep. 14, 2006

(54) Lithium secondary battery

(76) Inventors: Takuya Sunagawa, Naruto-shi (JP); Atsushi Fukui, Kobe-shi (JP); Taizou Sunano, Itano-gun (JP); Hiroshi Minami, Kobe-shi (JP); Shouichirou Sawa, Itano-gun (JP); Maruo Kamino, Itano-gun (JP); Toshihiko Saito, Awaji-shi (JP)

Correspondence Address: KUBOVCIK & KUBOVCIK, SUITE 710, 900 17TH STREET NW, WASHINGTON, DC, 20006, US

(21) Appl. No.: 11/372,219

(22) Filed: Mar. 10, 2006

(30) Foreign Application Priority Data
Mar. 11, 2005 (JP) 2005-068856

(51) Int. Cl. H01M 4/58; H01M 4/48

(52) U.S. Cl. 429/218.1; 429/231.1

(57) ABSTRACT

A lithium secondary battery is provided capable of significantly improving charge-discharge cycle performance by preventing gas generation originating from decomposition of the non-aqueous electrolyte while preventing manufacturing cost from increasing. A lithium secondary battery is provided with: a power generating element accommodated in a flexible battery case (6), the power generating element including a negative electrode (2), a positive electrode (1), and a non-aqueous electrolyte. The negative electrode contains negative electrode active material particles composed of silicon and/or a silicon alloy. The positive electrode contains a positive electrode active material composed of a lithium-transition metal composite oxide. The non-aqueous electrolyte contains ions of at least one element selected from the group consisting of Co, Cu, Mg, Mn, Ni, Fe, and Zr.

### BACKGROUND OF THE INVENTION

1. Field of the Invention

The present invention relates to lithium secondary batteries that use a material containing silicon as a negative electrode active material, and more particularly to improvements in non-aqueous electrolytes used for the lithium secondary batteries.

2. Description of Related Art

Rapid advancements in size and weight reductions of mobile information terminal devices such as mobile telephones, notebook computers, and PDAs in recent years have created demands for higher capacity batteries as driving power sources for the devices. With their high energy density and high capacity, lithium secondary batteries that perform charge and discharge by transferring lithium ions between the positive and negative electrodes have been widely used as the driving power sources for the mobile information terminal devices. It has been expected that, due to further size reduction and advanced functions of these portable devices, requirements for the lithium secondary batteries as the device power sources will continue to escalate in the future. Thus, demands for higher energy density in the lithium secondary batteries have been increasingly high.

An effective means to achieve higher energy density in a battery is to use a material having a greater energy density as its active material. Recently, silicon and silicon alloys, which intercalate lithium through an alloying reaction with lithium, have been studied and considered as candidates for the negative electrode active materials for lithium secondary batteries that are capable of higher energy density to replace carbon materials, such as graphite, which are currently in commercial use.

However, the use of silicon or a silicon alloy for the negative electrode of a lithium secondary battery has a problem as follows. Since the silicon or silicon alloy itself changes considerably in volume during charging and discharging, particles of the negative electrode active material pulverize and the surfaces of the negative electrode active material particles become porous as the charge-discharge cycling proceeds. As a result, the surface areas of the negative electrode active material particles significantly increase. Such an increase in the surface areas leads to an increase in the contact areas between the non-aqueous electrolyte and the negative electrode active material particles, promoting decomposition of the non-aqueous electrolyte. This leads to generation of a gas that derives from the decomposition of the non-aqueous electrolyte, resulting in swelling of the battery.

In view of this problem, the following proposals have been made.

(1) As shown in Japanese Published Unexamined Patent Application Nos. 2004-171874, 2004-171875, and 2004-311141, it has been proposed to coat the silicon surface with, for example, a thin film containing silicon oxide, an ion conductive inorganic compound, copper, or nickel, to thereby prevent decomposition of the non-aqueous electrolyte and improve cycle performance.

(2) As shown in Japanese Published Unexamined Patent Application No. 2004-171877, it has been proposed to coat the silicon surface with a decomposed product of cyclic carbonic ester that is contained in the non-aqueous electrolyte and has unsaturated bonds.

Nevertheless, the above-described conventional proposals have problems as follows.

Problem with Proposal (1)

The proposal (1) above requires an additional process step of coating a surface film on silicon particles, which raises the manufacturing cost of the battery. Moreover, the film with which silicon particles are coated may peel off or crack due to the change in volume during charging and discharging, and therefore, significant improvement in the charge-discharge cycle performance is impossible.

Problem with Proposal (2)

With the proposal (2), the non-aqueous electrolyte is impregnated into an organic surface film, and therefore, the reaction between the non-aqueous electrolyte and the silicon surface cannot be prevented sufficiently; thus, the proposal (2) is also unable to significantly improve the charge-discharge cycle performance.

### BRIEF SUMMARY OF THE INVENTION

Accordingly, it is a primary object of the present invention to provide a lithium secondary battery capable of significant improvement in charge-discharge cycle performance by controlling the gas generation originating from decomposition of the non-aqueous electrolyte while preventing the manufacturing cost of the battery from increasing.

In order to accomplish the foregoing and other objects, the present invention provides a lithium secondary battery comprising: a power generating element accommodated in a battery case, the power generating element including a negative electrode, a positive electrode, and a non-aqueous electrolyte; the negative electrode containing negative electrode active material particles composed of silicon and/or a silicon alloy; the positive electrode containing a positive electrode active material composed of a lithium-transition metal composite oxide; and the non-aqueous electrolyte containing at least one element selected from the group consisting of Co, Cu, Mg, Mn, Ni, Fe, and Zr, existing in the electrolyte in an ionic state.

When an element selected from the group consisting of Co, Cu, Mg, Mn, Ni, Fe, and Zr exists in the non-aqueous electrolyte in an ionic state, the ions deposit as a metal on the surfaces of the negative electrode active material particles composed of silicon and/or a silicon alloy during charge, or are alloyed with the silicon on the surfaces of the negative electrode active material particles during charge, and as a result, a strong surface film forms on the negative electrode active material particle surface. Since the presence of the surface film makes it possible to prevent the non-aqueous electrolyte from decomposing on the negative electrode active material particle surface, it becomes possible to prevent the battery from swelling. As a consequence, cycle performance improves.

Moreover, according to this technique, it is sufficient that at least one element selected from among the above-described group of elements, Co and so forth, exists in the non-aqueous electrolyte in an ionic state, and the process of forming a surface film on negative electrode active material particles in advance is unnecessary. Therefore, manufacturing cost of the battery does not rise.

Because the ions contained in the non-aqueous electrolyte, which exists inside the power-generating element, react with the negative electrode active material particles composed of particles of silicon and/or a silicon alloy during charge, the amount of the ions contained in the non-aqueous electrolyte decreases. It may seem possible that the decrease in the amount of the ions in the non-aqueous electrolyte existing inside the power-generating element and the like can lower the advantageous effects of the present invention. However, as the positive and negative electrodes expand and shrink during charging and discharging, the non-aqueous electrolyte that is inside the power-generating element, i.e., between a positive electrode and negative electrode of a wound electrode, is exchanged with the non-aqueous electrolyte that is outside the power-generating element, i.e., between a wound electrode and a battery case (note that the amount of the ions contained in the non-aqueous electrolyte that exists outside of the power-generating element does not decrease because the ions contained in that portion of the non-aqueous electrolyte do not react with the negative electrode active material particles during charge), and consequently, the ions contained in the non-aqueous electrolyte existing inside the power-generating element are prevented from a considerable decrease. As a consequence, the ions of an element selected from among the above-noted group of elements, Co and the like, are continuously supplied to the particle surfaces of silicon and/or a silicon alloy particles throughout the period in which a charge-discharge process is repeated, and therefore, the strong surface film can be sustained even if charging and discharging are repeated. Thus, the advantageous effects of the present invention do not lessen.

According to the present invention, the cycle performance of lithium secondary batteries that use a material containing silicon as its negative electrode active material can be improved remarkably.

### BRIEF DESCRIPTION OF THE DRAWINGS

FIG. 1 is a view schematically illustrating the states of the inside of the negative electrode before and after charging, with negative electrode active material particles that have an average particle size of 10 μm before charging.

FIG. 2 is a view schematically illustrating the states of the inside of the negative electrode before and after charging, with negative electrode active material particles that have an average particle size of 20 μm before charging.

FIG. 3 is a front view of the battery according to a preferred embodiment of the present invention.

FIG. 4 is a cross-sectional view taken along line A-A in FIG. 3.

### DETAILED DESCRIPTION OF THE INVENTION

The lithium secondary battery according to the invention comprises a power generating element provided with a negative electrode, a positive electrode, and a non-aqueous electrolyte, the power generating element accommodated in a battery case. The power generating element includes a negative electrode, a positive electrode, and a non-aqueous electrolyte. The negative electrode contains negative electrode active material particles composed of silicon and/or a silicon alloy. The positive electrode contains a positive electrode active material composed of a lithium-transition metal composite oxide. The non-aqueous electrolyte contains at least one element selected from the group consisting of Co, Cu, Mg, Mn, Ni, Fe, and Zr, existing in an ionic state.

In the present invention, when charging the lithium secondary battery, ions of the at least one element selected from the group consisting of Co, Cu, Mg, Mn, Ni, Fe, and Zr contained in the non-aqueous electrolyte are supplied from the non-aqueous electrolyte to surfaces of negative electrode active material particles so that the at least one element exists on the surfaces of the negative electrode active material particles.

The previously-described advantageous effects of the present invention are sufficiently exhibited with the above-described configuration, in which the ions of at least one element selected from among the above-noted group of elements, Co and so forth, contained in the non-aqueous electrolyte is supplied to the surfaces of the negative electrode active material particles when charging the lithium secondary battery so that the element exists on the surfaces of the negative electrode active material particles.

In the present invention, the negative electrode active material particles may have an average particle size of 15 μm or less before being charged.

This restriction is made because, if the average particle size of the negative electrode active material particles composed of silicon and/or a silicon alloy exceeds 15 μm before being charged, the shift in the positional relationship between the negative electrode active material particles, which occurs when the volume of the negative electrode active material particles changes by a charge-discharge operation, will become too large, and electrical contact between the negative electrode active material particles will tend to be lost.

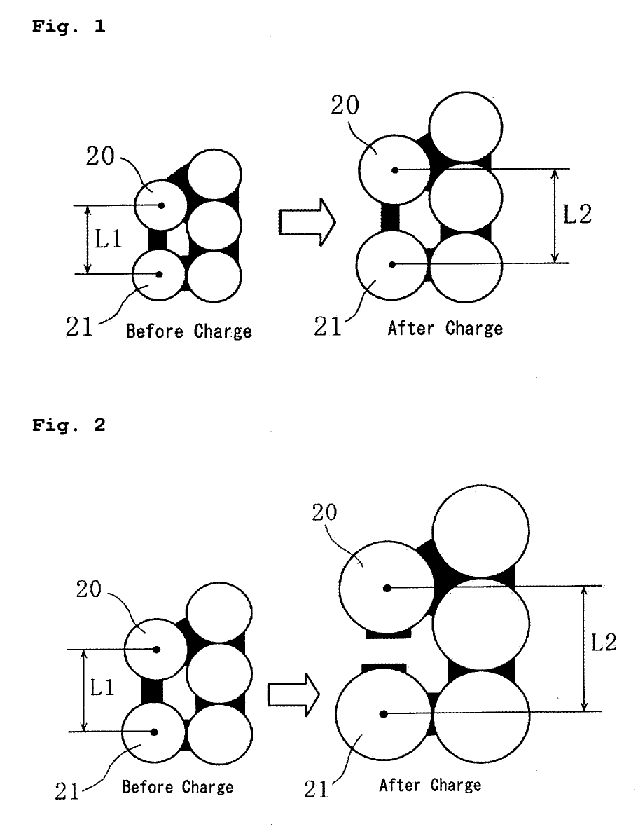

Specifically, considering the case, as illustrated in FIG. 1, that particles 20 and 21 of silicon or the like have an average particle size of 10 μm before charging (distance L1 between the particles 20 and 21=15 μm), and the case, as illustrated in FIG. 2, that particles 20 and 21 of silicon or the like have an average particle size of 20 μm before charging (distance L1 between the particles 20 and 21=30 μm). It should be noted that, after charging, the diameter of the particles 20 and 21 of silicon or the like expands and becomes two times that before charging. Accordingly, in the case shown in FIG. 1, the distance L2 between the particles 20 and 21 is approximately 30 μm after charging, and therefore electrical contact between the negative electrode active material particles is not apt to be lost. On the other hand, in the case shown in FIG. 2, the distance L2 between the particles 20 and 21 is large, approximately 60 μm after charging, and therefore electrical contact between the negative electrode active material particles tends to be easily lost. Thus, electrical contact is easily lost between the negative electrode active material particles when the average particle size is large before charging.

If electrical contact is lost between the particles before the surface film is sufficiently formed by charging, the surface film will no longer be formed beyond a certain point; therefore, decomposition of the non-aqueous electrolyte will be promoted at that portion. For the reason discussed above, it is desirable that the average particle size be 15 μm or less.

In the present invention, the negative electrode active material particles may be silicon particles.

This restriction is made because the capacity of the lithium secondary battery increases most when the negative electrode active material particles are silicon particles. It should be noted that, although the change in volume of the negative electrode active material particles is greatest during charging and discharging when the negative electrode active material particles are made of only silicon particles, decomposition of the non-aqueous electrolyte can be sufficiently prevented because ions of Co or the like exist in the non-aqueous electrolyte and a surface film is formed on the surfaces of the negative electrode active material particles during charge.

In the present invention, the battery case may be flexible.

This restriction is made because the advantageous effects of the present invention will be exhibited most notably when the battery case has flexibility, in which case swelling of the battery tends to easily occur. An example of the battery case that has flexibility includes, but is not limited to, a later-described aluminum laminate battery case.

Primary Components of the Battery

Positive Electrode

(a) Examples of the lithium-transition metal composite oxide as a positive electrode active material include LiCoO₂, LiNiO₂, LiMn₂O₄, LiCuo_{0.5}Ni_{0.5}O₂, and LiNi_{0.33}Co_{0.33}Mn_{0.34}O₂. Particularly preferable are LiCoO₂, and layered-structure lithium-transition metal composite oxides containing Li, Ni, Mn, and Co.

(b) It is preferable that the BET specific surface area of the lithium-transition metal composite oxide be 3 m²/g or less. The reason is that, if the BET specific surface area of the lithium-transition metal composite oxide exceeds 3 m²/g, the reactivity thereof with the non-aqueous electrolyte will increase because the contact area of the lithium-transition metal composite oxide with the non-aqueous electrolyte is too large, causing side reactions, such as gas generation originating from the decomposition reaction of the non-aqueous electrolyte, to occur more easily.

(c) It is preferable that the average particle size of the lithium-transition metal composite oxide (average particle size of secondary particles) be 20 μm or less. The reason is that, if the average particle size exceeds 20 μm, the distance of diffusion of the lithium within the particles of the lithium-transition metal composite oxide will be too large, degrading charge-discharge cycle performance.

(d) It is preferable that the positive electrode be such that a positive electrode mixture layer containing a lithium-transition metal composite oxide as a positive electrode active material, an oxide, a positive electrode conductive agent, and a positive electrode binder, is disposed on a conductive metal foil as a positive electrode current collector.

(e) Various known conductive agents may be used for the positive electrode conductive agent. Preferable examples include a conductive carbon material, and acetylene black and Ketjen Black are particularly preferable.

It is preferable that the amount of the positive electrode conductive agent with respect to the positive electrode mixture layer be from 1 mass % to 5 mass %. The reason is as follows. If the amount of the positive electrode conductive agent with respect to the positive electrode mixture layer is less than 1 mass %, the amount of the conductive agent is so small that a sufficient conductive network cannot be formed around the positive electrode active material. Therefore, the current collection performance within the positive electrode mixture layer lowers and thus charge-discharge performance degrades. On the other hand, if the amount of the positive electrode conductive agent with respect to the positive electrode mixture layer exceeds 5 mass %, the amount of the conductive agent will be so large that the binder is consumed to bond the conductive agent, resulting in poor adherence between positive electrode active material particles and poor adherence of the positive electrode active material with the positive electrode current collector. Consequently, the positive electrode active material tends to peel off easily, degrading charge-discharge performance.

(f) Various known binders may be used as the positive electrode binder without limitation as long as the binders do not dissolve in the solvent of the non-aqueous electrolyte in the present invention. Preferable examples include fluororesins such as polyvinylidene fluoride, polyimide-based resins, and polyacrylonitriles.

It is preferable that the amount of the positive electrode binder be from 1 mass % to 5 mass % of the positive electrode mixture layer. The reason is as follows. If the amount of the positive electrode binder is less than 1 mass % of the positive electrode mixture layer, contact areas between positive electrode active material particles increase, reducing the contact resistance; however, adherence between the positive electrode active material particles and adherence of the positive electrode active material with the positive electrode current collector become poor because the amount of the binder is too small, causing the positive electrode active material to peel off easily and consequently lowering charge-discharge performance. On the other hand, if the amount of the positive electrode binder exceeds 5 mass % of the positive electrode mixture layer, adherence between the positive electrode active material particles and adherence of the positive electrode active material with the positive electrode current collector will improve; however, the amount of the binder is so large that contact areas between the positive electrode active material particles will reduce, increasing contact resistance and thus degrading charge-discharge performance.

(g) Various conductive metal foils may be used as the positive electrode current collector without limitation as long as they do not dissolve in the non-aqueous electrolyte and are stable at the potential applied to the positive electrode during charging and discharging. Preferable examples include aluminum foil.

(h) It is preferable that the density of the positive electrode mixture layer be 3.0 g/cm³ or greater. The reason is that, when the density of the positive electrode mixture layer is 3.0 g/cm³ or greater, contact areas within the positive electrode active material increase and current collection performance within the positive electrode mixture layer improves, making it possible to obtain good charge-discharge performance.

Non-Aqueous Electrolyte

(a) Usable examples of the solvent of the non-aqueous electrolyte include, but are not particularly limited to, cyclic carbonates such as ethylene carbonate, propylene carbonate, butylene carbonate, and vinylene carbonate; chain carbonates such as dimethyl carbonate, ethyl methyl carbonate, and diethyl carbonate; esters such as methyl acetate, ethyl acetate, propyl acetate, methyl propionate, ethyl propionate, and γ-butyrolactone; ethers such as 1,2-dimethoxyethane, 1,2-diethoxyethane, tetrahydrofuran, 1,2-dioxane, and 2-methyltetrahydrofuran; nitrites such as acetonitrile; and amides such as dimethylformamide. These solvents may be used either alone of in combination. Particularly preferred is a mixed solvent of a cyclic carbonate and a chain carbonate.

(b) Examples of the solute of the non-aqueous electrolyte in the present invention include, but are not particularly limited to: lithium compounds represented by the chemical formula LiXF_{y} (wherein X is P, As, Sb, B, Bi, Al, Ga, or In; and either y is 6 when X is P, As, or Sb; or y is 4 when X is B, Bi, Al, Ga, or In), such as LiPF₆, LiBF₄, LiAsF₆; as well as lithium compounds such as LiCF₃SO₃, LiN(CF₃SO₂)₂, LiN(C₂F₅SO₂)₂, LiN(CF₃SO₂) (C₄F₉SO₂) LiC(CF₃SO₂)₃, LiC(C₂F₅SO₂)₃, LiClO₄, Li₂B₁₀Cl₁₀, and Li₂B₁₂Cl₁₂. Among them, LiPF₆ is particularly preferred.

(c) Examples of the additive of the non-aqueous electrolyte in the present invention include, but are not particularly limited to: M(A)ₓ (wherein M is Co, Cu, Mg, Mn, Ni, Fe or Zr and A is NO₃, ClO₄, BF₄, PF₆ or C₅HF₆O₂; and either x is 2 when M is Co, Cu, Mg, Mn, Ni or Fe; x is 3 when M is Fe; or x is 4 when M is Zr).

Negative Electrode

(a) It is preferable that the negative electrode be such that a negative electrode mixture layer that contains a negative electrode binder and particles containing silicon and/or a silicon alloy as a negative electrode active material is disposed on a conductive metal foil as a negative electrode current collector.

The negative electrode active material is included in the negative electrode mixture layer in an amount of at least 10 mass %. When the amount of the negative electrode active material is less than 10 mass %, capacity of the negative electrode including the silicon and/or silicon alloy is equal to or less than that of a negative electrode including carbon and there is no benefit to using silicon and/or silicon alloy for the negative electrode.

(b) Examples of the silicon alloy include solid solutions of silicon and at least one other element, intermetallic compounds of silicon and at least one other element, and eutectic alloys of silicon and at least one other element.

(c) It is preferable that the particle size distribution of the negative electrode active material be as narrow as possible. If the particle size distribution is wide, a large difference in particle size among active material particles will result in a large difference in the absolute amount of expansion and shrinkage associated with lithium intercalation and deintercalation, producing strain in the mixture layer. As a result, destruction in the binder occurs, degrading the current collection performance in the electrode and thereby lowering charge-discharge performance.

(d) It is preferable that the conductive metal foil as the negative electrode current collector have a surface roughness Ra of 0.2 μm on the surface on which the negative electrode mixture layer is disposed. When using a conductive metal foil having such a surface roughness Ra as the negative electrode current collector, the binder gets into the portions of the current collector surface in which the surface irregularities exist, exerting an anchoring effect and thereby providing strong adherence between the binder and the current collector. As a result, it is possible to prevent the peeling off of the mixture layer from the current collector, which is due to the expansion and shrinkage in volume of the active material particles that are associated with the lithium intercalation and deintercalation. In the case that both surfaces of the current collector are provided with the negative electrode mixture layer, it is preferable that the surface roughness Ra be 0.2 μm or greater on both surfaces of the negative electrode. To provide the current collector with a surface roughness Ra of 0.2 μm or greater, the conductive metal foil may be subjected to a roughening process. Examples of the roughening process include plating, vapor deposition, etching, and polishing.

It is preferable that the just-mentioned surface roughness Ra and mean spacing of local peaks S have a relationship 100 Ra≧S. Surface roughness Ra and mean spacing of local peaks S are defined in Japanese Industrial Standards (JIS B 0601-1994) and can be measured by, for example, a surface roughness meter.

The conductive metal foil current collector may be, for example, a foil of a metal such as copper, nickel, iron, titanium, or cobalt, or may be an alloy foil formed of a combination thereof.

(e) It is particularly preferable that the conductive metal foil current collector have a high mechanical strength. The reason is as follows. The high mechanical strength of the current collector prevents destruction or plastic deformation of the current collector even if the current collector undergoes a stress resulting from change in volume of the silicon negative electrode active material at the time of lithium intercalation and deintercalation, and alleviates the stress. Consequently, the mixture layer is prevented from peeling off from the current collector, and the current collection performance in the electrode is maintained. Thus, good cycle performance can be obtained.

(f) Although not particularly limited, the thickness of the conductive metal foil negative electrode current collector is preferably within the range of from 10 μm to 100 μm.

In addition, the upper limit of the surface roughness Ra of the conductive metal foil negative electrode current collector in the present invention is not particularly limited; however, as noted above, because it is preferred that the thickness of the conductive metal foil be within the range of from 10 μm to 100 μm, the upper limit of the surface roughness Ra should essentially be 10 μm or less.

(g) In the negative electrode, it is preferable that the thickness X of the negative electrode mixture layer have the relationships with current collector thickness Y and surface roughness Ra represented by 5Y≧X and 250Ra≧X, respectively. If the mixture layer thickness X is either greater than 5 Y or greater than 250Ra, the expansion and shrinkage in volume of the mixture layer during charging and discharging are so great that adherence between the mixture layer and the current collector cannot be maintained by the irregularities on the current collector surface, causing the mixture layer to peel off from the current collector.

Although not particularly limited, the thickness X of the negative electrode mixture layer is preferably 1000 μm or less, and more preferably from 10 μm to 100 μm.

(h) It is preferable that the negative electrode binder have a high mechanical strength and good elasticity. Employing a binder with good mechanical properties makes it possible to prevent binder destruction even if change in volume of the negative electrode active material occurs during lithium intercalation and deintercalation, and enables the mixture layer to change in shape according to the change in volume of the silicon active material. As a consequence, the current collection performance in the electrode is maintained, and outstanding charge-discharge performance is obtained. A preferable example of the binder having good mechanical properties is polyimide resin. Fluoropolymers such as polyvinylidene fluoride and polytetrafluoroethylene may also be suitably used.

(i) It is preferable that the amount of the negative electrode binder be 5% or greater of the total mass of the negative electrode mixture layer, and that the volume of the binder be 5% or greater of the total volume of the negative electrode mixture layer. If the amount of binder is less than 5% of the total mass of the mixture layer, or the volume of the binder is less than 5% of the total volume of the mixture layer, adherence within the electrode originating from the binder is insufficient because the amount of the binder is too small relative to the negative electrode active material particles. On the other hand, if the amount of the binder is too large, resistance within the electrode will increase, making charging at the initial stage difficult. Therefore, it is preferable that the amount of the negative electrode binder be 50% or less of the total mass of the negative electrode mixture layer, and that the volume of the binder be 50% or less of the total volume of the negative electrode mixture layer. It should be noted that the total volume of the negative electrode mixture layer means the total of the volumes of the materials such as active material and binder, and that it does not include the volume of space in the mixture layer if such space exists in the mixture layer.

(j) In the negative electrode, conductive powder may be mixed in the mixture layer. By adding conductive powder, a conductive network of the conductive powder forms around the active material particles, making it possible to further improve the current collection performance in the electrode. Preferable materials for the conductive powder may be the same materials as those for the conductive metal foil. Specific examples include metals such as copper, nickel, iron, titanium, and cobalt as well as alloys and mixtures thereof. In particular, copper powder is preferable as the powder of metal. Conductive carbon powder may also be preferably used.

(k) It is preferable that the amount of the conductive powder to be mixed into the negative electrode mixture layer be 50% or less of the total mass of the negative electrode active material, and that the volume occupied by the conductive powder be 20% or less of the total volume of the negative electrode mixture layer. The reason is that, if the amount of the conductive powder added is too large, the relative proportion of the negative electrode active material correspondingly reduces in the negative electrode mixture layer, and consequently the charge-discharge capacity of the negative electrode decreases. Moreover, in this case, because the proportion of the amount of the binder reduces with respect to the total amount of the active material and the conductive agent in the mixture layer, an additional problem arises that the strength of the mixture layer lessens, degrading charge-discharge performance.

Although not particularly limited, the average particle size of the conductive powder is preferably 100 μm or less, more preferably 50 μm or less, and most preferably 10 μm or less.

(l) It is further preferable that the negative electrode be such that the negative electrode mixture layer including a binder and active material particles containing silicon and/or a silicon alloy is sintered on a surface of the conductive metal foil serving as the negative electrode current collector and disposed on the surface. When the mixture layer is disposed on the current collector surface by sintering, adherence between active material particles and adherence between the mixture layer and the current collector are greatly improved by the effect of sintering, so that the current collection performance of the mixture layer can be maintained even if change in volume of the silicon negative electrode active material occurs during lithium intercalation and deintercalation. Thus, good charge-discharge performance can be obtained.

(m) In the case of (l) above, it is preferable that the negative electrode binder be thermoplastic. For example, if the negative electrode binder has a glass transition temperature, the sintering for disposing the negative electrode mixture layer on the negative electrode current collector surface may be performed at a temperature higher than the glass transition temperature. This causes the binder to thermally bond with the active material particles and the current collector, further improving adherence between active material particles and adherence between the mixture layer and the current collector further. Thus, it is possible to greatly improve the current collection performance in the electrode, and to obtain better charge-discharge performance.

(n) In the case of (l) above, it is preferable that the negative electrode binder not decompose but remain in the negative electrode mixture layer even after the sintering for disposing the negative electrode mixture layer on the negative electrode current collector surface. The reason is that if the binder is completely decomposed after the sintering, the adhering effect originating from the binder is lost so that the current collection performance in the electrode greatly lowers, resulting in very poor charge-discharge performance.

(o) It is preferable that the sintering for disposing the negative electrode mixture layer on the negative electrode current collector surface be carried out under vacuum, or under a nitrogen atmosphere, or under an inert gas atmosphere such as an argon atmosphere. It is also possible to carry out the sintering under a reducing atmosphere such as a hydrogen atmosphere. It is preferable that the baking temperature in the sintering be less than the temperature at which the binder resin starts to thermally decompose, because the negative electrode binder should preferably remain in the mixture layer without completely being decomposed. Examples of the method for the sintering include a discharge plasma sintering technique and hot pressing.

(p) It is preferable that the negative electrode in the present invention be fabricated by uniformly mixing and dispersing particles containing silicon and/or a silicon alloy, serving as the negative electrode active material, into a solution of the negative electrode binder to thereby prepare a negative electrode mixture slurry, and applying the resultant negative electrode mixture slurry onto a surface of a conductive metal foil, serving as the negative electrode current collector. The mixture layer thus produced using the slurry in which active material particles are uniformly mixed and dispersed in a binder solution has a structure in which the binder is uniformly distributed around the active material particles. This makes it possible to exploit maximum benefit from the mechanical properties of the binder, to attain high electrode strength, and to thereby obtain good charge-discharge cycle performance.

### PREFERRED EMBODIMENTS OF THE INVENTION

Hereinbelow, the present invention is described in further detail based on preferred embodiments thereof. It should be construed, however, that the present invention is not limited to the following preferred embodiments and various changes and modifications are possible without departing from the scope of the invention.

Preparation of Negative Electrode

First, silicon powder (purity: 99.9%) having an average particle size of 3 μm as a material for the negative electrode active material was mixed into a N-methylpyrrolidone solution containing 20 mass % thermoplastic polyimide with a glass transition temperature of 190° C., serving as a binder, to thus prepare a negative electrode mixture slurry. The mass ratio of silicon powder and polyimide in the negative electrode mixture slurry was 9:1.

Next, the negative electrode mixture slurry thus prepared was applied onto one side of a 35 μm-thick electrolytic copper foil, serving as the current collector, the one side having been roughened to provide a surface roughness Ra of 1.5 μm and mean spacing of local peaks S of 100 μm, and then dried. Next, the resultant material was cut out into dimensions of 380 mm×52 mm, then pressure-rolled, and sintered by baking it under an argon atmosphere at 400° C. for 1 hour. Lastly, a nickel metal piece serving as the negative electrode current collector tab was attached to an edge of the sintered material thus obtained. Thus, a negative electrode was prepared.

Preparation of Positive Electrode

First, Li₂CO₃ and CoCO₃ were used as starting materials, and they were weighed so that the atomic ratio Li:Co became 1:1 and mixed in a mortar. The resultant mixture was pressure-formed by pressing with a stamping die with a diameter of 17 mm, and then baked in the air at 800° C. for 24 hours, to thus obtain a baked material of LiCoO₂.

Next, the baked material was pulverized in a mortar so as to have an average particle size of 20 μm.

Subsequently, the resultant LiCoO₂ powder, artificial graphite powder as a conductive agent, and polyvinylidene fluoride as a binder agent were mixed in N-methylpyrrolidone as a solvent, to thus form a positive electrode mixture slurry. The mass ratio of the LiCoO₂ powder, artificial graphite powder, and polyvinylidene fluoride was 94:3:3.

Thereafter, the positive electrode mixture slurry was applied onto one side of an aluminum foil serving as a current collector. The resultant material was dried and thereafter pressure-rolled. Lastly, the resultant material was cut out into dimensions of 340 mm×50 mm, and an aluminum metal piece serving as the positive electrode current collector tab was attached to an edge thereof. Thus, a positive electrode was prepared.

Preparation of Non-Aqueous Electrolyte Solution

First, LiPF6 was dissolved at a concentration of 1 mole/liter into a mixed solvent of 3:7 volume ratio of ethylene carbonate and diethyl carbonate. Next, bis(hexafluoroacetylacetonato)cobalt(II) was dissolved into the mixed solvent at a concentration of 8.2 mmol/L. A non-aqueous electrolyte solution was thus prepared.

Preparation of Battery

The positive electrode and the negative electrode prepared as described above were wound in a hollow cylindrical form with a 27 μm-thick porous polyethylene separator interposed therebetween. The cylindrical wound electrode assembly was pressed into a flat shape, and thereafter the flat wound electrode assembly and the non-aqueous electrolyte solution were accommodated into a battery case made of aluminum laminate under an atmospheric pressure argon atmosphere at room temperature. Thus, a secondary battery was prepared.

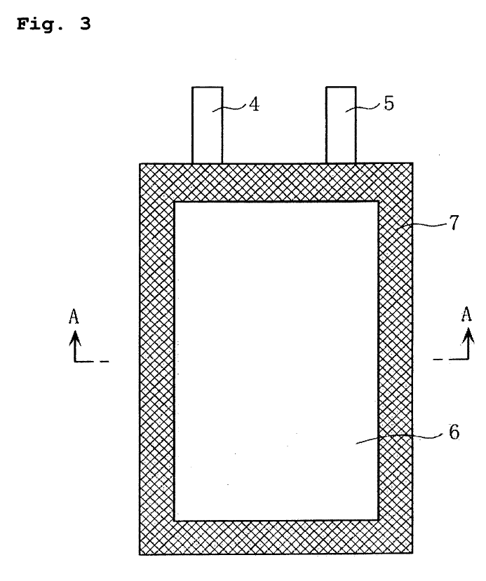

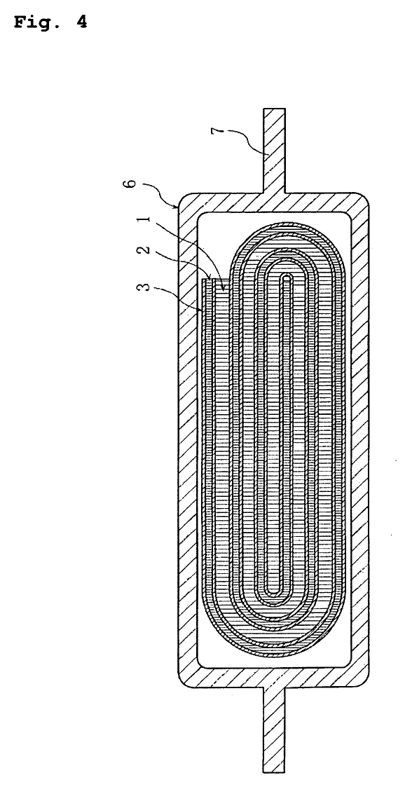

The specific structure of the lithium secondary battery was as follows. As illustrated in FIGS. 3 and 4, a positive electrode 1 and a negative electrode 2 are disposed so as to oppose each other with a separator 3 interposed therebetween, whereby a power-generating element is constituted by the positive electrode 1, the negative electrode 2, the separator 3, and the non-aqueous electrolyte solution. The positive electrode 1 and the negative electrode 2 are connected to a positive electrode current collector tab 4 made of aluminum metal and a negative electrode current collector tab 5 made of nickel metal, respectively, forming a structure capable of charge and discharge as a secondary battery. The power-generating element made of the positive electrode 1, the negative electrode 2, and the separator 3 is accommodated in a space of an aluminum laminate battery case 6 having a sealed part 7 at which end parts of the aluminum laminate were heat sealed.

### EXAMPLES

### Example 1

A lithium secondary battery was fabricated according to the above-described preferred embodiment of the invention.

The battery thus fabricated is hereinafter referred to as Battery A1 of the invention.

### Examples 2 to 8

Lithium secondary batteries were fabricated in the same manner as in Example 1, except that addition agents added to the non-aqueous electrolyte solution in place of bis(hexafluoroacetylacetonato)cobalt(II) were bis(hexafluoroacetylacetonato)copper(II), bis(hexafluoroacetylacetonato)magnesium(II), bis(hexafluoroacetylacetonato)manganese(II), bis(hexafluoroacetylacetonato)nickel(II), tris(hexafluoroacetylacetonato)iron(III), tetrakis(trifluoro-2,4-pentanedionato)zirconium(IV), and manganese fluoroborate, respectively.

The batteries thus fabricated are hereinafter referred to as Batteries A2 to A8 of the invention, respectively.

### Comparative Example

A lithium secondary battery was fabricated in the same manner as in Example 1, except that no addition agent was added to the non-aqueous electrolyte.

The battery thus fabricated is hereinafter referred to as Comparative Battery X.

Experiment

Batteries A1 to A8 of the invention and Comparative Battery X were charged and discharged for 100 cycles under the charge-discharge conditions set out below, and thereafter they were stored at 25° C. for 3 months. The battery thickness increases thereof were found by measuring the thicknesses of the batteries before and after the storage. The results are shown in Table 1 below.

Charge-Discharge Conditions

Charge Conditions

The batteries were charged with a constant current of 500 mA until the battery voltage reached 4.2 V. Thereafter, the batteries were constant voltage charged while keeping the battery voltage at 4.2 V until the current value reached 25 mA. The temperature was 25° C.

Discharge Conditions

The batteries were discharged with a current of 500 mA until the battery voltage reached 2.7 V. The temperature was 25° C.

TABLE 1

| | Addition agent to electrolyte solution | | Battery |
|---|---|---|---|
| Battery | Type of addition agent | Amount added | thickness increase |
| A1 | Bis(hexafluoroacetylacetonato)cobalt(II) | 8.2 mmol/L | 0.356 mm |
| A2 | Bis(hexafluoroacetylacetonato)copper(II) | 8.2 mmol/L | 0.345 mm |
| A3 | Bis(hexafluoroacetylacetonato)magnesium(II) | 8.9 mmol/L | 0.312 mm |
| A4 | Bis(hexafluoroacetylacetonato)manganese(II) | 8.3 mmol/L | 0.441 mm |
| A5 | Bis(hexafluoroacetylacetonato)nickel(II) | 8.3 mmol/L | 0.447 mm |
| A6 | Tris(hexafluoroacetylacetonato)iron(III) | 5.8 mmol/L | 0.263 mm |
| A7 | Tetrakis(trifluoro-2,4-pentanedionato)zirconium(IV) | 5.5 mmol/L | 0.453 mm |
| A8 | Manganese fluoroborate | 27.5 mmol/L | 0.224 mm |
| X | No addition agent | — | 0.498 mm |

Table 1 clearly demonstrates that Batteries A1 to A8 of the invention, in which ions of an element selected from the group consisting of Co, Cu, Mg, Mn, Ni, Fe, and Zr exist in the non-aqueous electrolyte, showed battery thickness increases of from 0.224 mm to 0.453 mm, indicating that the battery thickness increase was controlled. On the other hand, Comparative Battery X, in which ions of an element selected from the group of elements, Co and so forth, do not exist in the non-aqueous electrolyte, showed a battery thickness increase of 0.498 mm, indicating that the battery thickness increase was not controlled. The reason can be attributed as follows. In Comparative Battery X, it is believed that the non-aqueous electrolyte decomposed and produced a large amount of gas, which expanded the aluminum laminate battery case. In contrast, in Batteries A1 to A8 of the invention, it is believed that the presence of the ions of an element selected from among the above-noted group of elements controlled the gas generation originating from decomposition of the non-aqueous electrolyte, preventing the expansion of the aluminum laminate battery case.

### Additional Embodiments

(1) Although the amount of the additive to the non-aqueous electrolyte was 8.2 mmol/L in the foregoing examples, the amount of the additive is not limited thereto and may be 0.03 mmol/L to 82.5 mmol/L based on the amount of electrolyte.

When the amount of the additive is less than 0.3 mmol/L, the amount of additive is not sufficient and a film is formed on the negative electrode active material and decomposition of the electrolyte cannot be sufficiently prevented. When the amount of the additive is greater than 82.5 mmol/L, a film on the negative electrode active material is too thick and normal charge and discharge reaction is inhibited to reduce capacity.

(2) Although only one kind of additive to the non-aqueous electrolyte was used in each of the batteries of the foregoing examples, it is of course possible to use two or more additives in the non-aqueous electrolyte in one battery.

(3) The additive to the non-aqueous electrolyte solution is not limited to bis(hexafluoroacetylacetonato)cobalt(II) and so forth that have been specified above, but may be cobalt(II) nitrate, cobalt(II) perchlorate, cobalt(II) phosphate, cobalt(II) hexafluorophosphate, cobalt (II) fluoroborate, cobalt bis(pentafluoroethanesulfone)imide, cobalt bis(trifluoromethanesulfone)imide, cobalt trifluoromethanesulfonate, and the like.

The foregoing likewise applies to bis(hexafluoroacetylacetonato)copper(I), bis(hexafluoroacetylacetonato)magnesium(II), bis(hexafluoroacetylacetonato)manganese(II), bis(hexafluoroacetylacetonato)nickel(II), tris(hexafluoroacetylacetonato)iron(III), tetrakis(trifluoro-2,4-pentanedionato)zirconium(IV), and manganese fluoroborate.

The present invention is applicable not only to driving power sources for mobile information terminals such as mobile telephones, notebook computers, and PDAs, but also to large-sized batteries for, for example, in-vehicle power sources for electric automobiles or hybrid automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application No. 2005-068856 filed Mar. 11, 2005, which is incorporated herein by reference.

What is claimed is:

1. A lithium secondary battery comprising:
a power generating element accommodated in a battery case, the power generating element including a negative electrode, a positive electrode, and a non-aqueous electrolyte;
the negative electrode containing negative electrode active material particles composed of silicon and/or a silicon alloy;
the positive electrode containing a positive electrode active material composed of a lithium-transition metal composite oxide; and
the non-aqueous electrolyte containing at least one element selected from the group consisting of Co, Cu, Mg, Mn, Ni, Fe, and Zr in an amount of at least 0.3 mmol/L, said at least one element existing in an ionic state.

2. The lithium secondary battery according to claim 1, wherein, when the lithium secondary battery is charged, ions of the at least one element selected from the group consisting of Co, Cu, Mg, Mn, Ni, Fe, and Zr contained in the non-aqueous electrolyte are supplied from the non-aqueous electrolyte to surfaces of negative electrode active material particles so that the at least one element exists on the surfaces of the negative electrode active material particles without being dissolved in the non-aqueous electrolyte.

3. The lithium secondary battery according to claim 1, wherein the negative electrode active material particles have an average particle size of 15 μm or less before being charged.

4. The lithium secondary battery according to claim 2, wherein the negative electrode active material particles have an average particle size of 15 μm or less before being charged.

5. The lithium secondary battery according to claim 1, wherein the negative electrode active material particles are silicon particles.

6. The lithium secondary battery according to claim 2, wherein the negative electrode active material particles are silicon particles.

7. The lithium secondary battery according to claim 3, wherein the negative electrode active material particles are silicon particles.

8. The lithium secondary battery according to claim 4, wherein the negative electrode active material particles are silicon particles.

9. The lithium secondary battery according to claim 1, wherein the battery case is flexible.

10. The lithium secondary battery according to claim 2, wherein the battery case is flexible.

11. The lithium secondary battery according to claim 3, wherein the battery case is flexible.

12. The lithium secondary battery according to claim 4, wherein the battery case is flexible.

13. The lithium secondary battery according to claim 5, wherein the battery case is flexible.

14. The lithium secondary battery according to claim 6, wherein the battery case is flexible.

15. The lithium secondary battery according to claim 7, wherein the battery case is flexible.

16. The lithium secondary battery according to claim 8, wherein the battery case is flexible.
